(19) United States
(12) Patent Application Publication
(10) Pub. No.: US 2015/0108211 A1
(43) Pub. Date: Apr. 23, 2015

(54) SYSTEM AND METHOD FOR AUTHENTICATION USING NEAR-FIELD COMMUNICATION

(71) Applicant: Identifide Inc., Fullerton, CA (US)

(72) Inventors: Christopher T. Higgins, Placentia, CA (US); Hardeep S. Johar, Pasadena, CA (US); Joseph C. Silva, Grand Terrace, CA (US)

(21) Appl. No.: 14/521,895

(22) Filed: Oct. 23, 2014

Related U.S. Application Data
(60) Provisional application No. 61/894,858, filed on Oct. 23, 2013.

(51) Int. Cl. G06K 5/00

(52) U.S. Cl. CPC G06K 5/00
USPC 235/375

(57) ABSTRACT

A system for authentication an item comprises a software program executing on a server having one or more sets of instructions executable on a processor of the server. A first set of instructions of the one or more sets of instructions is configured to receive a code scanned from the item. A second set of instructions of the one or more sets of instructions is configured to authenticate the code. A third set of instructions of the one or more sets of instructions configured to transmit a message regarding the authentication of the item, wherein the first set of instructions receives the code as scanned form the item as a pass-through with respect to the mobile device whereby the second set of instructions are further configured to directly authenticate the NFC tag on the server and not on the mobile device.

### CROSS REFERENCE OF RELATED APPLICATIONS

The present application claims priority from U.S. Provisional Patent Application No. 61/894,858, entitled “SYSTEM AND METHOD FOR AUTHENTICATION USING NEAR-FIELD COMMUNICATION” filed on Oct. 23, 2013, the contents of which are hereby incorporated by reference in its entirety.

### FIELD OF THE INVENTION

This invention generally relates to a system and method for authentication using near-field communication. More specifically, the invention provides a product authentication system to companies and suppliers in order to authenticate websites and products.

### BACKGROUND

The problem of counterfeiting is pervasive and presents a significant problem for not only the manufacturers and companies that counterfeiting directly impacts based on a substitution of merchandise and a resulting loss of revenue, but also in the areas in which counterfeiting profits fund potentially illicit activities. In typical situations, counterfeiting is the substitution of legitimate products for copies or clones of lesser quality, and these counterfeit products hurt revenues of the companies selling legitimate products and can directly harm or even kill the consumer. This happens when the counterfeit product contains dangerous or harmful ingredients and even toxic substances which the end customer is unwittingly using or ingesting from these fake products.

As for specific instances of counterfeiting the United States Organization for Economic Co-operation and Development (OECD) as well the United Nations Office on Drugs and Crime (UNODC) provide innumerable statistics and examples of counterfeiting across industries and put global numbers between 5-7% of world trade. Pharmaceutical counterfeiting may have the most human casualties as compromised products are extremely harmful and includes medicines for the treatment of malaria, TB, and HIV/AIDS. Pharmaceutical counterfeiting mostly affects developing countries that lack proper regulation and enforcement. The largest amount of counterfeiting occurs in the fashion industry, including with regard to clothing, accessories, and shoes. Although these products are not directly harmful to the consumer, the OECD and UNODC both tie these black market profits to the mafia, crime syndicates, and terrorism. There are a significant number of reasons to combat counterfeiting based on the innumerable negative consequences produced from the counterfeiting industry.

Working to counteract counterfeiting is conducted for various purposes and on a variety of fronts including identifying counterfeit suppliers, identifying supply chains, or attempting to validate end product legitimacy. If a consumer can validate the legitimacy of a product they will be better informed whether or not the product is counterfeit and can choose to make a purchase based on that additional information. Current anti-counterfeiting implementations include special stitching, threads, and fabrics, serial numbers and other codes, certificates, tags, and a variety of other techniques.

None of the previous techniques provide an effective way of guaranteeing product legitimacy because either they do not work, are difficult to use, or the technique itself can be compromised. Furthermore, none of the previous systems, taken either singularly or in combination, anticipate or make obvious the instant invention as claimed. Thus, a combination that solves the aforementioned problems is desired.

### SUMMARY OF THE INVENTION

In order to solve the problems and shortcomings of the prior art, according to one preferred embodiment, a system for authenticating an item comprises: a software program executing on a server having one or more sets of instructions executable on a processor of the server; a first set of instructions of the one or more sets of instructions configured to receive a code scanned from the item; a second set of instructions of the one or more sets of instructions configured to authenticate the code; and a third set of instructions of the one or more sets of instructions configured to transmit a message regarding the authentication of the item.

In another preferred embodiment, a method for authentication an item comprises: receiving a code scanned from the item at a server; authenticating the code on the server; and transmitting a message regarding the authentication of the item from the server.

### BRIEF DESCRIPTION OF THE DRAWINGS

FIG. 1 is a diagrammatic representation of an exemplary internet-based environment in which one embodiment may operate;

FIG. 2 is a block diagram illustrating an embodiment of the authentication system according to the invention;

FIG. 3 is a diagrammatic representation of one or more of the servers of FIGS. 1 and 2, and a storage device with a database containing electronic data that is transformed; and

FIG. 4 is a flow chart illustrating steps performed by a video display software according to the embodiment of FIGS. 1-3.

### DETAILED DESCRIPTION OF THE PREFERRED EMBODIMENTS

For the purpose of illustrating the invention, there is shown in the accompanying drawings several embodiments of the invention. However, it should be understood by those of ordinary skill in the art that the invention is not limited to the precise arrangements and instrumentalities shown therein and described below.

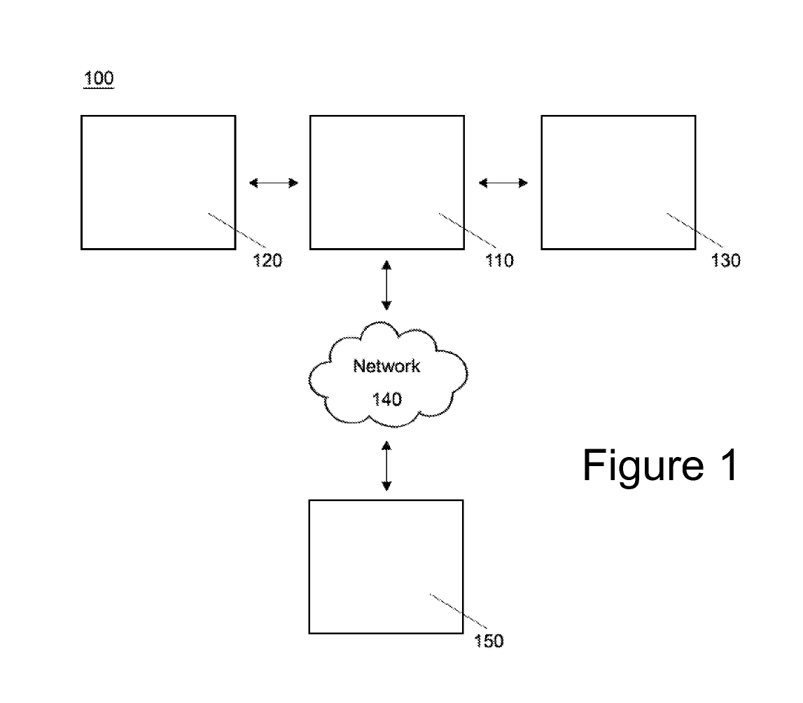

The system and method described herein fights counterfeiting at the product level, at a point before, during, or after a purchase, in accordance with preferred embodiments of the present invention and is illustrated in FIGS. 1-4 wherein like reference numerals are used throughout to designate like elements.

With reference to FIG. 1, a diagrammatic representation of an exemplary internet-based system is shown in which the system and method may operate according to one embodiment. A dynamic QR code on a website 120 or NFC tag on a product 130 may be read by a mobile device 110 in order to establish the authenticity of the website 120 or product 130 respectively. However, on some embodiments, instead of use of an NFC tag 132, a combination of a processor and WiFi, BlueTooth, eInk, liquid crystal display (LCD), or other communication mediums could be used as a replacement to the NFC tag 132. Further, instead of a QR code 122, a standard barcode or other optical transform could be used to communicate a code for authentication between a website and the mobile device 110. The mobile device 110 communicates over the data network 140 to the server 150 which can complete the authentication procedure. The authentication procedure conducted through this system provides a unique method of authentication along with a minimization of any potential to thwart the system.

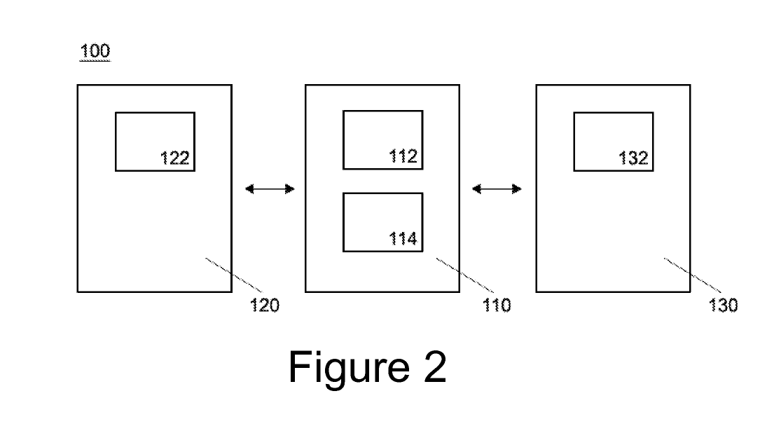

FIG. 2 depicts a more detailed view of the communication between the mobile device's 110 camera subsystem 112 and the QR code 122 as well as the mobile device's 110 RF subsystem 114 and the NFC device 132. The mobile device 110 may include a camera subsystem 112 and RF subsystem 114. In addition, the mobile device 110 can be any device which is able to scan a QR code on a website 120 or communicate with a tag on a product 130 such as an NFC tag.

Since the website 120 or product 130 has a QR Code 122 or NFC tag 132 respectively. The authentication method translates the authenticity from the QR code or NFC tag to the accompanying website or product.

The mobile device 110 may scan the QR code 122 on the website 120 or read the NFC tag 132 within the product 130, and transmit the data read from either or both to the server 150. There are at least two embodiments described herein: the first with an NFC tag 132, mobile device 110, and server 150; and the second with a QR code 122, mobile device 110, and server 150.

### NFC Tag Usage:

In one embodiment, the system comprises an NFC device or tag 132 within the product 130. The mobile device 110 accesses server 150 accessed over the network 140. There are several mechanisms utilized within this embodiment that provide unique methods for achieving authentication and validation that a given NFC device 132 is universally authentic. The following mechanisms can be combined in a number of ways to achieve a sufficient level of authentication.

In one embodiment, pass-through authentication is used. Typical authentication methodologies rely on direct authentication between a mobile device and NFC device. However this typical situation presents security concerns arising from the security flaws of the mobile device itself. Rather than authenticate directly with the mobile device, one embodiment includes authenticating with the server 150 directly by communicating through the mobile device 110 and over the network 140. This is achieved by accessing the NFC device's 132 encrypted authentication data from the mobile device 110 and passing that through the network 140 to the server 150 and back again. This encrypted data is exchanged until the NFC device is sufficiently authenticated with the server and thus no unencrypted data traverses the network 140 and no encryption keys ever leave the server 150.

In another embodiment, random number check technology is used. Within this embodiment, a random number is utilized in order to catch counterfeiters in the act. If during every read/write cycle to the NFC device 132 from the mobile device 110 a randomly generated (non-contiguous nor consistent in any way) number is written to the NFC device's 132 memory and the server 150 keeps track of that random number, then the server 150 knows by correlating the unique ID (UID) that never changes on a given chip to the random number, thus the knowledge that a given tag has been duplicated is achieved as any further scanning of a counterfeit chip would be known since the random number would be incorrect.

In another embodiment, multi-layer authentication is used. Although the pass-through authentication previously described is preferred, some situations may include a “local” authentication mechanism directly between the mobile device 110 and the NFC device 132 without the need to communicate to the server 150 or over the network 140. This means that the mobile device 110 may have knowledge of the encryption keys of the NFC device 132. In this embodiment, given space, the software for authentication, and the authentication data or keys themselves are downloaded locally to the mobile device.

In one embodiment, locally stored data packets may be used. Extra information, including the possibility to specify product 130 specific information such as the manufacturer, tracking information, beginning of life, end of life, special discount codes, prize codes, marketing codes, location codes, and product IDs can also be stored within the device. This information can be plaintext but also could be encrypted in one of three ways: with a unique NFC device specific encryption, with an encryption related to the UID of the NFC device, or with a subset of encryption keys.

In another embodiment unique IDs (UIDs) may be used. A globally unique ID may be specific to only one given tag and implemented from the NFC device 122 manufacturers' factory. It is a unique identifying number that should be globally unique appearing on individual NFC devices 132.

In another embodiment, the chip type and version may be used. The chip type and version may be written to the NFC device 132 in order to keep track of what type of NFC device 132 is included in a product 130 as well as versioning information for the mobile device 110 and server 150.

### QR Code Usage:

In one embodiment, a system comprises using a QR code 122 within the website 120, the mobile device 110, and server 150 accessed over the network 140. There is one main mechanism utilized within this embodiment that provides a unique method for achieving authentication and validation for a given QR Code 122. It is understood that an authenticated QR code can provide several advantages including indicating that the website 120 and the products or company represented on that website has thus also been authenticated by the third party QR code 122 provider.

In one embodiment, an application on the mobile device 110 is utilized. Typically, QR code scanning apps for mobile devices may be provided by the same third party supplier that supplies the QR codes 122. The user of the mobile device 110 can utilize this application to authenticate specific QR codes 122. The specific QR codes 122 may be generated in the following way in order to provide this authentication. Since a QR code is simply an image that a visual camera may scan and decode, the website 120 that houses the QR code 122 may dynamically generate the QR code sourced from the third party supplier. Once generated, the QR Code 122 is then scanned using the mobile device 110 through its camera subsystem 112. The reason a dynamically generated code may be used, and not simply be static code, is to provide a method for the QR code to expire by utilizing a timestamp or piece of information to indicate this period of validity. Once the mobile device 110 scans the QR code using the application provided by the third party supplier, the QR code is decoded and its data is utilized to provide the user with authentication information.

### The Mobile Device

The mobile device 110 may be the customer interface to the NFC device 132 and the QR code 122. The mobile device may also be the interface to the backend server 150 using its network connection 140. This network connection 140 may be used to communicate with the server 150 with information about the NFC device 132 and QR Code 122. Because of this central role, there are also some functions that the mobile device may handing in certain embodiments, which may be combined with the other embodiments described herein.

In one embodiment, local authentication is used. The mobile device 110 may decode information stored on the NFC tag 132 to provide an intermediary authentication decision. This could be useful in locations where quick authentication is required or where network access 140 is not readily available.

In another embodiment, product information is used. The mobile device 110 may provide the customer with additional product information regarding the website 120 or product 130 following the scanning of the QR code 122 or NFC device 132. This information could include additional details including size, color, cost, purchase locations, birth date, manufacturing location, and whether it is made in USA. This information may be transferred by the mobile device 110 to the server 150 over the network 140.

Another embodiment may use instant product registration. Following the scanning of the QR code 122 or NFC tag 132, the mobile device 110 may provide instantaneous product registration over the network 140.

Another embodiment may use a product keychain. Following the scanning of the QR code 122 or NFC tag 132, the mobile device 110 may provide the customer a way to save their previously purchased products in a virtual keychain. This information may be transferred by the mobile device 110 to the server 150 over the network 140 and stored either on the server 150 or within the mobile device's 110 memory.

Another embodiment may use social media. Following the scanning of the QR code 122 or NFC tag 132, the mobile device 110 may provide a gateway to immediately post information about the website 120 or product 130 scanned to social media sources.

Another embodiment may reload balance information and track activity. If the NFC device or tag 132 is embedded in another device, such as a coffee mug, scanning the NFC device 132 with a mobile device 110 may track usage, activity, and even maintain, deduct, or replenish virtual currency. This information may be transferred by the mobile device 110 to the server 150 over the network 140 and stored either on the server 150 or within the mobile device's 110 memory.

Another embodiment may allow unique games. The mobile device 110 may be used to scan NFC devices 132 physically located in certain locations (such as theme parks, malls, stores) in order to gain points, credit, or money within a particular game. This information may be transferred by the mobile device 110 to the server 150 over the network 140 and stored either on the server 150 or within the mobile device's 110 memory.

Another embodiment stores user information. The mobile device 110 may pass along information about the user at certain intervals or when a NFC device 132 is scanned. This information can include details such as location, phone number, phone id, user, and age. This information may be transferred by the mobile device 110 to the server 150 over the network 140 and stored either on the server 150 or within the mobile device's 110 memory.

Another embodiment may be used for marketing information. The mobile device 110 provides a mechanism to display marketing information to the user based on the NFC device 132 or QR Code 122 that is scanned. This information may be transferred by the mobile device 110 to the server 150 over the network 140.

### The Server

The server 150 may be the central location to collect customer information and may also be the communication point to the mobile device 110 over the data network 140. The information collected by the mobile device 110 and sent to the server 150 can either be sourced from the mobile device 110 itself, the NFC device 132, or the QR code 122.

In one embodiment, the server may collect product information. Information can be collected from the NFC device 132 or QR Code 122 scans regarding where the scan is taking place, what is being scanned, who is scanning the product 130 or website 120, and other identifying information.

In another embodiment, the server may store user information. Information can be collected from NFC device 132 or QR Code 122 scans regarding who is buying certain products including name, age, location, phone type, hardware information, browser information, time, date, and other identifying information.

In another embodiment, the server may provide counterfeiting reports. Information can be collected from NFC device 132 or QR Code 122 scans regarding the geolocation of where potential counterfeit products are being sold based on invalid scans.

In another embodiment, the server may award prizes or conduct sweepstakes. Random or preset information coupled to a specific NFC device 132 or QR Code 122 may be created on the server 150, which when the NFC device 132 or QR Code 122 is scanned, triggers a mechanism to support prizes and sweepstakes.

In another embodiment, pre-purchase reports may be created. Information can be collected from NFC device 132 or QR Code 122 scans regarding what products are scanned prior to a purchase. This information could support determining what items are popular, why things may not be getting sold, which products need to be moved around in the store, among other reasons.

In another embodiment, the server may store purchasing habits. Information can be collected from NFC device 132 or QR Code 122 scans regarding information on individual users and their buying habits over a range of product lines, timelines, and locations among other information.

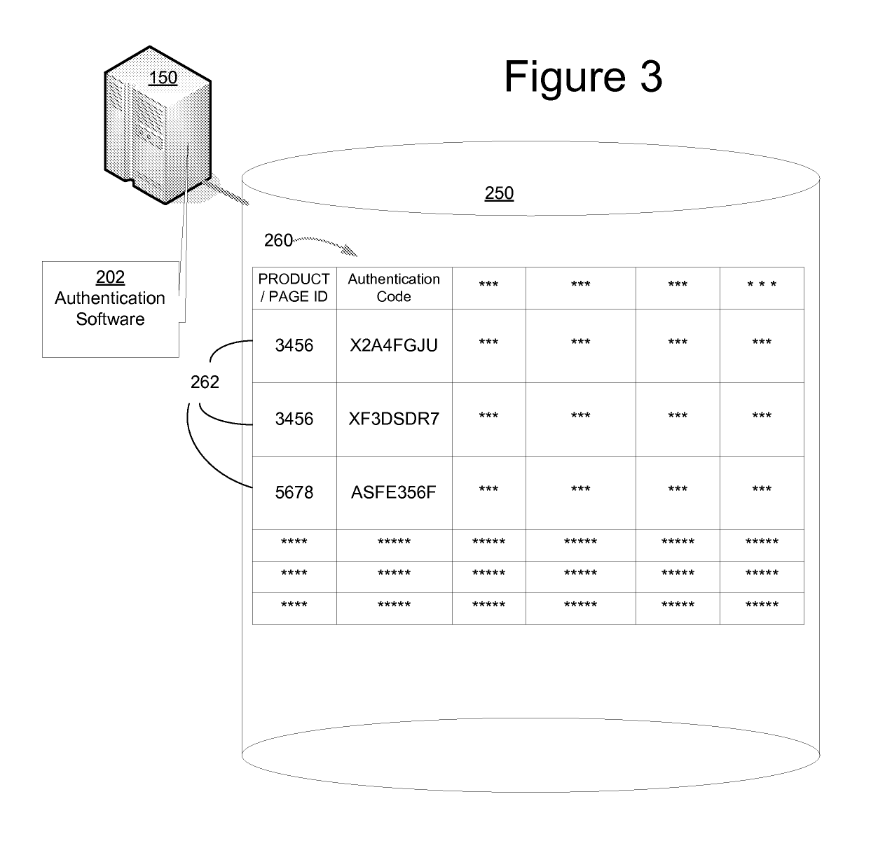

With reference to FIG. 3, a diagrammatic representation is shown of a server according to the embodiments of FIGS. 1 and 2, and a storage device with a database containing electronic data that is transformed to conduct embodiments of the methods described herein. Authentication software 202 may contain computer instructions that are executable on server 150. Further, in electronic communication with server 150 are one or more storage devices 250 that contain an authentication database 260 having authentication records 262. For example, each authentication record may contain fields used to authenticate the websites and products. Some of the fields may contain, for example, a product or page identification or identifier, and authentication codes.

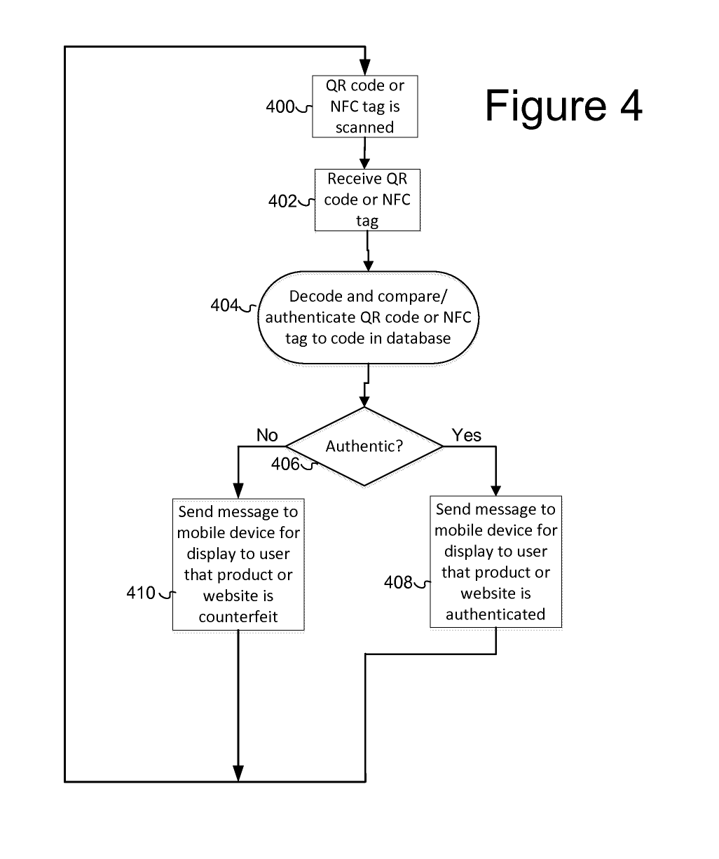

With reference to FIG. 4, a flow chart illustrates steps performed by authentication software according to the embodiment of FIGS. 1-3. In step 400, a QR code 122 or NFC tag 132 is scanned with a mobile device or other scanning device. In step 402, the server 150 receives the QR code 122 or NFC tag 132 scanned by the mobile device. In step 404, the received code is decoded (if encrypted) and compared to, or authenticated with, the authentication code for the matching product ID in database 260 (after searching for the record 262 for the product or website). If the product or website is found to be authenticated, step 406, then in step 408, the software 202 sends a message to the mobile device for display to user that product or website is authenticated. Otherwise, in step 410, a message is sent to the mobile device that the product is not authenticated, or may be counterfeit.

### Utilization Of The System And Method

The embodiments described herein may be applied and utilized in a variety of ways. For example, for anti-counterfeiting and authentication, the NFC device 132 may be applied to luxury goods and other things. As an example, if a fashion company or designer wants to ensure that no one could make a counterfeit based off of their products, they could attach, adhere, or embed an NFC device 132 into the product. Scanning the NFC-protected product by a customer would quickly authenticate that product. Specific examples of where this can be used is handbags, purses, clothing (shirts, jeans, pants, socks, jackets, coats), sunglasses, belts, accessories, alcohol and wine, watches, electronics, and exercise equipment, or any situation in which the NFC device 132 could be applied.

For parts, when products are made in remote locations, there is a large problem with genuine parts being substituted for counterfeit parts. So for example, a company might make product in Mexico and attach, adhere, or embed an NFC device 132 on critical components to ensure they are not substituted. In the military, metal and other crucial components of equipment are also targets for counterfeiting so this NFC device 132 can insure that genuine parts are used throughout the manufacturing/service of military equipment. Another example is if a product is sent to China to be assembled, the critical components can have this NFC device 132 to make sure that fraudulent parts are not used to replace genuine counterparts.

For memorabilia, whether its art, antiques, sports memorabilia or the like, counterfeiters try to sell their fakes as genuine. To attach, adhere, or embed an NFC device 132 would provide a unique authentication mechanism more secure than paper certificates of authenticity.

For certifications, identifications, and paperwork, from false driver's licenses, fraudulent customs paperwork, or even currency, all of these items, and the like, can be guaranteed to be genuine by attaching, adhering, or embedding this NFC device 132.

For pharmaceuticals and cigarettes, the NFC device 132 could be attached, adhered, or embedded to make sure the medication or cigarettes are authentic. In addition, the combination of the NFC device 132, mobile device 110, and server 150 could provide the ability to maintain a digital log to ensure dosages are not missed and taken according to authorized instructions for pharmaceutical products by tracking the scan of a product and correlating it to a prescribed schedule through a mobile or other computer interface.

In one embodiment, holograms can be replaced. An NFC device 132 could replace the use of holograms as a more secure means of protecting everything from sports goods to toys or even be used alongside or embedded within the hologram itself.

In another embodiment, mass authentication may be conducted. Using ultra-sensitive mobile devices 110 which can read an NFC device 132 from a longer distance, businesses can detect counterfeit items on a mass scale. Such as a whole store at a time. For example if Blu-Ray discs use an NFC device 132, the entire store can be scanned by the ultra-sensitive mobile device. This can be beneficial if a store is known to sell Blu-Ray disks but the scan doesn't show any NFC tags are in the store, then there is counterfeiting or piracy happening.

In another embodiment, the system can be used for geo-location. When the NFC device 132 or QR code 122 is scanned by a mobile device 110, the geo-location may be recorded to the server 150 and can be utilized to detect counterfeit goods, items, or sales in order to prosecute or shut down these occurrences.

In another embodiment, the system can be used for marketing. The NFC device 132 may be used to gather information about customer analytics (age, location, what products they are interested in, among other information), and sales information (where, when, who's buying, among other information):

In another embodiment, the system may promote promotional products. An NFC device 132 may be embedded internally into products (such as in a mug) with the potential of winning games or prizes based on the NFC device 132 itself or random information related to when, where, or what was scanned. This could also include promotional products which provide customer analytics and are activated upon scan. Such as a reusable Dunkin Donuts® cup which may have a chip or NFC tag 132 embedded into it and it is scanned every time a customer purchases a cup of coffee. This would tell Dunkin Donuts information about the customer as well as reward the customer by providing a free cup of coffee on every n-th occasion.

Analytics may determine which marketing campaigns are more effective, which can be determined by placing an NFC device 132 in various environments to determine which is more popular, more often noticed, or more regularly scanned.

In one embodiment, product registration: Instantaneous product registration could be accomplished following the scan of an NFC device 132 or QR code 122 by the mobile device 110 where the mobile device 110 provides this extra service.

One embodiment may conduct inventory tracking. The NFC device 132 can be used as a replacement to legacy inventory tracking mechanisms such as UPC codes, QR codes, or RFID devices which are only used for the single purpose of inventory tracking. An NFC device 132 may have multiple purposes including that of an inventory tracking mechanism as well the other functionalities listed herein. Combining these functionalities gives the NFC device 132 and thus attached product 130 a traceable pedigree describing the lifecycle of the product 130 and NFC device 132.

The various embodiments described above are provided by way of illustration only and should not be construed to limit the invention. Those skilled in the art will readily recognize various modifications and changes that may be made to the claimed invention without following the example embodiments and applications illustrated and described herein, and without departing from the true spirit and scope of the claimed invention, which is set forth in the following claims.

What is claimed is:

1. A system for authentication an item comprising:
a software program executing on a server having one or more sets of instructions executable on a processor of the server;
a first set of instructions of the one or more sets of instructions configured to receive a code scanned from the item;
a second set of instructions of the one or more sets of instructions configured to authenticate the code; and
a third set of instructions of the one or more sets of instructions configured to transmit a message regarding the authentication of the item.

2. The system of claim 1, wherein the item is a web site.

3. The system of claim 2, wherein the website comprises a QR code that is scanned and received by the server for authentication.

4. The system of claim 1, wherein the item is a product.

5. The system of claim 4, wherein the product comprises an NFC tag that is scanned and received by the server for authentication.

6. The system of claim 4, wherein the first set of instructions receives the NFC tag as scanned form the item as a pass-through with respect to the mobile device whereby the second set of instructions are further configured to directly authenticate the NFC tag on the server and not on the mobile device.

7. The system of claim 6, wherein the second set of instructions is configured to use an authentication method selected from the group consisting of a least one of the following: pass-through authentication; random number checking using a unique ID; multi-layer authentication;
stored data packets; and checking a unique product ID and checking a chip type and version.

8. A method for authentication an item comprising:
receiving a code scanned from the item at a server;
authenticating the code on the server; and
transmitting a message regarding the authentication of the item from the server.

9. The method of claim 8, wherein the item is a web site.

10. The method of claim 9, wherein the website comprises a QR code that is scanned and received by the server for authentication.

11. The method of claim 8, wherein the item is a product.

12. The method of claim 11, wherein the product comprises an NFC tag that is scanned and received by the server for authentication.

13. The method of claim 12, comprising receiving the NFC tag as scanned form the item as a pass-through with respect to the mobile device thereby authenticating the NFC tag on the server and not on the mobile device.

14. The method of claim 13, wherein the step of authenticating comprises using a method selected from the group consisting of a least one of the following: pass-through authentication; random number checking using a unique ID; multi-layer authentication; stored data packets; and checking a unique product ID and checking a chip type and version.
